(19) United States
(12) Patent Application Publication
(10) Pub. No.: US 2004/0180121 A1
(43) Pub. Date: Sep. 16, 2004

(54) Transparent/translucent edible ice cream cones and processes

(76) Inventors: Jacob J. Thomas, Eugene, OR (US); Sean G. Westcott, Eugene, OR (US)

Correspondence Address: Robert E. Howard, P.O. Box 10345, Eugene, OR, 97440, US

(21) Appl. No.: 10/702,684

(22) Filed: Nov. 5, 2003

Related U.S. Application Data
(63) Continuation-in-part of application No. 10/386,734, filed on Mar. 11, 2003.

(51) Int. Cl. B32B 3/10

(52) U.S. Cl. 426/139

(57) ABSTRACT

An edible ice cream cone having a top that is open and a bottom that is closed, and formed from a composition that is a transparent and/or translucent edible glass. The edible glass can be formed from a high-boiled sucrose and glucose syrup, a high-boiled maltitol syrup, a high-boiled isomalt, or a high-boiled modified isomalt. The ice cream cones can be formed from the high-boiled composition by molding or rolling.

### CROSS-REFERENCE TO RELATED APPLICATIONS

This is a continuation-in-part of application Ser. No. 10/386,734, filed Mar. 11, 2003.

### BACKGROUND OF THE INVENTION

The present invention relates to transparent and/or translucent edible ice cream cones, and to processes for making the cones.

Conventional edible ice cream cones are made from pastry compositions. The pastry composition is molded or rolled to form the shaped cone precursor, and the shaped cone precursor baked. Such cones are opaque.

It would be fun and artistically pleasing to have an edible ice cream cone where the ice cream can be at least partially seen through the cone by providing an edible cone that is transparent and/or translucent.

### SUMMARY OF THE INVENTION

It is an object of the present invention to provide a transparent and/or translucent edible ice cream cone.

It is a further object of the present invention to provide one or more processes for making the transparent and/or translucent edible ice cream cones.

The edible ice cream cone of the present invention has a top that is open and a bottom that is closed. The cone has a composition that is a transparent and/or translucent edible glass. The edible glass can be formed from a high-boiled sucrose and glucose syrup, a high-boiled maltitol syrup, a high-boiled isomalt, or a high-boiled modified isomalt.

The ice cream cones can be formed by molding or rolling the high-boiled composition.

### DESCRIPTION OF PREFERRED EMBODIMENTS

Whenever the phrase “ice cream cone” is used herein relative to the present invention, it is intended to include the traditional conical-shaped cone as well as any other ice cream “cone” shape made from pastry compositions, such as cups, deep hollow wafers, etc, all of which are open at the top and closed at the bottom. The opening in such cones is generally circular.

The ice cream cones of the present invention can be essentially smooth, waffled or otherwise textured, and can be formed by molding or rolling.

The compositions used to form the ice cream cones of the present invention include those that are used to form “hard” candy, which is sometimes called “high-boiled candy”.

A basic high-boiled composition useful in the present invention includes sucrose (sugar) and a glucose syrup (e.g., corn syrup), sometimes called the “doctoring syrup”.

In a modified high-boiled composition, maltitol syrup comprised of maltitol and hydrogenated oligosaccharides can be used to replace both the sugar and the glucose syrup of the basic composition. The maltitol level and the hydrogenated oligosaccharides in the maltitol syrup control the crystallizing property of maltitol in the same way as glucose syrup controls the crystallizing property of sucrose in the basic composition.

A sugar free high-boiled composition uses isomalt to replace the sugar and glucose syrup of the basic composition or the maltitol of the modified composition. Isomalt belongs to the class of disaccharide polyols like maltitol. Isomalt consists of two components in a 1:1 ratio: 1,6-glucopyranosyl-D-sorbitol (GPS) and 1,1-glucopyranosyl-D-mannitol (GPM).

In addition to being sugar free, there are a number of other advantages to using isomalt. Isomalt has a much lower hygroscopicity than maltitol syrup, which provides a finished cone that is less “sticky” under adverse (hot and humid) atmospheric conditions. Cones made using isomalt have a slower rate of micro-crystallization on the surface of the cone. Isomalt also reduces the tendency of the composition to undergo Maillard reactions (browning) during processing.

Modified isomalt compositions that are commercially available can also be used in making the cones of the present invention. One such composition is IsoMaltidex LQ 16510 sold by Cerestar. This composition includes isomalt, maltitol and hydrogenated oligosaccharides.

To form the ice cream cone of the present invention using the basic high-boiled composition, the sugar, water and corn syrup are combined in a volume ratio of about 2:1:0.75, and the mixture heated to a temperature of between about 290-310 degrees F. (the “hard crack stage”). Colorants and/or flavorants can then be added. The “high boiled” mixture can be formed into a cone by pouring the mixture onto a non-sticking flat surface to form a hot, pliable, circular sheet, and rolling the hot, pliable sheet around a conical mandrel to form a cone, the tip of the cone being sealed by pinching shut.

Alternatively, the high boiled mixture can be poured into a non-sticking cone mold.

Upon cooling, the molded or rolled high boiled mixture. forms a stable, rigid, transparent or translucent, edible “glass” ice cream cone.

Where maltitol syrup is used in the high-boiled composition, the mass is cooked to a temperature of about 168 degrees C. and a vacuum applied to achieve a residual moisture content of less than about 10%. Cones are then formed by either molding or rolling the high boiled mass. Upon cooling, the molded or rolled high boiled mass forms a stable, rigid transparent or translucent edible “glass” ice cream cone.

Where isomalt is used in the high-boiled composition, the mass is cooked to a temperature of about 155 degrees C. and a vacuum applied to achieve a residual moisture content of about 1.5%. Cones are then formed from the high boiled mass by either molding or rolling. Upon cooling, the molded or rolled high boiled mass forms a stable, rigid transparent or translucent edible “glass” ice cream cone.

Where modified isomalt high-boiled compositions are used, the manufacturer's instructions for forming the high-boiled mass hard candy precursor is followed. Cones are formed from the high-boiled mass by either molding or rolling. Upon cooling, the molded or rolled high boiled mass forms a stable, rigid transparent or translucent edible “glass” ice cream cone.

Any commercially available food colorant can be added to the high boiled mass, either alone or in combination, to provide ice cream cones having a color. Colorants can be added to provide a uniform color throughout the ice cream cone structure, or added in a manner to provide a non-uniform color, such as a swirled pattern.

Where a non-uniform color pattern is formed, the ice cream cone may be transparent in some areas and translucent or opaque in other areas. Thus, whenever the phrase “transparent and/or translucent” is used to describe the ice cream cones of the present invention, it is intended to include ice cream cones that are solely transparent, solely translucent, both transparent and translucent, both transparent and opaque, both translucent and opaque, and a combination of transparent, translucent and opaque.

Any commercially available food flavorant, such as a flavored candy oils or sweeteners, can be added to the high boiled mass, either alone or in combination, to impart a flavor and/or enhanced sweetness to the ice cream cone.

Colorants and flavorants are preferably not used in an amount that would cause the edible glass forming the cone to lose substantially all of its transparency and/or translucency.

### EXAMPLE 1

The following ingredients were placed into a saucepan:

1.25 cups of granulated sugar

⅓ cup of corn syrup

½ cup of water

⅛ teaspoon of citric acid

The saucepan was placed on the burner of an electric stove at a setting of high, and heated until the mixture reached 280 degrees F. The heat was lowered to medium high, and heating continued until the mixture reached a temperature of 300 degrees F., forming a high-boiled composition. The saucepan was removed from the burner and let stand until bubbling subsided (at a temperature of about 260 degrees F.). A flavorant (⅔ teaspoon) and colorant (2 drops) were added to the high-boiled composition, and the composition stirred until the flavorant and colorant were blended into the composition. The composition was then poured onto the bottom, circular platen of a waffle cone maker. The waffle cone maker was one made by Revel. The upper circular platen was lowered into contact with the bottom platen. The platens have a waffle pattern, and pressing the platens together cause the high-boiled composition to form a waffled disk having a diameter of about eight inches. After the waffled disk had cooled for a short while, but was still warm and pliable, it was removed from the waffle cone maker and wrapped around the conical mandrel supplied with the “Waffle Cone Express” to form a translucent, melon colored waffle cone. The bottom of the cone was pinched shut, and the cone removed from the mandrel. The cone weighed 75 grams.

In the process of forming the ice cream cones of the present invention described above, the term “molding” has been used to describe a batch process. However, the term “molding” is intended to also include the alternative processes described below.

A first alternative molding process includes forming a high-boiled, extrudable mixture in an injection molding extruder and injecting the extrudable mass into an injection molding mold to form at least one ice cream cone, and preferably a plurality of ice cream cones.

A second alternative molding process includes the steps of forming a high-boiled, extrudable mixture in an extruder, extruding the high boiled, extrudable mixture through a die to form sheets or strands, cooling the extruded sheets or strands, grinding or chopping the sheets or strands into powder or pellets, feeding the powder or pellets to an injection molding extruder, forming an extrudable mass in the injection molding extruder, and injecting the extrudable mass into an injection molding mold to form at least one ice cream cone, and preferably a plurality of ice cream cones.

Instead of forming an ice cream cone directly from a molten mass of a high-boiled composition, the high-boiled composition may be molded into a thin disk which is cooled to ambient temperature, whereupon it becomes rigid. The rigid disks, or ice cream cone precursors, are then shipped to an ice cream retailer who forms an ice cream cone from the rigid disk by heating the rigid disk to a temperature where it becomes pliable, and rolling the pliable disk around a mandrel to form a cone. Such ice cream cone precursor disks can be made having a waffle or other pattern, or no pattern (i.e., smooth). Such ice cream cone precursor disks have a diameter dependent upon the size of the cone to be made therefrom. For an average size cone the diameter of the disk would be about eight inches. For larger cones the diameter could be up to about twelve inches. For smaller cones the diameter could be about six inches. The thickness of the ice cream precursor disk can vary from about one millimeter up to about five millimeters, preferably between about one and about three millimeters.

While the ice cream cones of the present invention have been described as having been formed from certain high-boiled foodstuff compositions that form a rigid edible glass that is transparent and/or translucent, any other foodstuff composition that can be molded or rolled to form a rigid, edible glass ice cream cone that is transparent and/or translucent may be used.

It will be obvious to those having skill in the art that many changes may be made to the details of the above-described embodiments of this invention without departing from the underlying principles thereof. The scope of the present invention should, therefore, be determined only by the following claims.

The invention claimed is:

1. An edible ice cream cone, said cone having a top that is open and a bottom that is closed, said cone having a composition that is a transparent and/or translucent edible glass.

2. The edible ice cream cone of claim 1 wherein said edible glass is formed from a high-boiled composition including sucrose and glucose syrup.

3. The edible ice cream cone of claim 1 wherein said edible glass is formed from a high-boiled maltitol syrup.

4. The edible ice cream cone of claim 1 wherein said edible glass is formed from a high-boiled isomalt.

5. The edible ice cream cone of claim 1 wherein said edible glass is formed from a high-boiled modified isomalt.

6. The edible ice cream cone of claim 1 wherein said composition includes at least one colorant.

7. The edible ice cream cone of claim 6 wherein said colorant is uniformly distributed throughout said cone.

8. The edible ice cream cone of claim 6 wherein said colorant is non-uniformly distributed throughout said cone.

9. The edible ice cream cone of claim 1 wherein said composition includes at least one flavorant.

10. The ice cream cone of claim 1 in which said top is substantially circular.

11. The process of forming an edible ice cream cone having a composition that is a transparent and/or translucent edible glass, comprising:
preparing a high-boiled composition selected from the group consisting of sucrose and glucose syrup, maltitol syrup, isomalt, and a modified isomalt;
forming the high-boiled composition into at least one circular disk; and
while said circular disk is still pliable wrapping said circular disk around a conical mandrel to form a cone.

12. The process of forming an edible ice cream cone having a composition that is a transparent and/or translucent edible glass, comprising:
forming a high-boiled, extrudable composition selected from the group consisting of sucrose and glucose syrup, maltitol syrup, isomalt, and a modified isomalt in an extruder; and
feeding the high-boiled, extrudable composition to a mold to form at least one ice cream cone.

13. The process of forming an edible ice cream cone having a composition that is a transparent and/or translucent edible glass, comprising:
forming a high-boiled, extrudable composition selected from the group consisting of sucrose and glucose syrup, maltitol syrup, isomalt, and a modified isomalt in an extruder;
passing the high-boiled, extrudable composition through a die to form a sheet or strand;
grinding or chopping said sheet or strand to form a powder or pellets;
feeding said powder or pellets to an injection molding extruder;
processing the powder or pellets in said extruder at a temperature that forms an extrudable mass; and
injecting the extrudable mass into a mold to form at least one ice cream cone.

14. The process of forming an edible ice cream cone having a composition that is a transparent and/or translucent edible glass, comprising:
forming a high-boiled composition selected from the group consisting of sucrose and glucose syrup, maltitol syrup, isomalt, and a modified isomalt;
forming the high-boiled composition into a circular disk;
cooling said circular disk to ambient temperature to form a rigid circular disk;
heating said rigid circular disk to a temperature where said disk becomes pliable; and
wrapping said pliable, circular disk around a conical mandrel to form a cone.

15. A transparent and/or translucent edible ice cream cone precursor comprising a rigid disk of a high-boiled composition selected from the group consisting of sucrose and glucose syrup, maltitol syrup, isomalt, and a modified isomalt.

16. The ice cream cone precursor of claim 15 wherein said disk has a diameter of between about six and about twelve inches.

17. The ice cream cone precursor of claim 15 wherein said disk has a thickness of between about one and about five millimeters.
